(19) United States
(12) Patent Application Publication
(10) Pub. No.: US 2023/0302574 A1
(43) Pub. Date: Sep. 28, 2023

(54) HIGH-ENERGY GLASS CUTTING

(71) Applicant: TRUMPF Laser- und Systemtechnik GmbH, Ditzingen (DE)

(72) Inventors: Jonas Kleiner, Leonberg (DE); Daniel Flamm, Ludwigsburg (DE); Tim Hesse, Ditzingen (DE); Malte Kumkar, Weimar (DE); Myriam Kaiser, Heimsheim (DE)

(21) Appl. No.: 18/327,899

(22) Filed: Jun. 2, 2023

Related U.S. Application Data
(63) Continuation of application No. PCT/EP2021/080197, filed on Oct. 29, 2021.

(30) Foreign Application Priority Data
Dec. 8, 2020 (DE) 10 2020 132 700.5

(51) Int. Cl. B23K 26/0622; C03B 33/08

(52) U.S. Cl. CPC B23K 26/0624; C03B 33/082; B23K 2103/54

(57) ABSTRACT

A method for severing an at least partially transparent material includes focusing ultrashort laser pulses, as individual laser pulses and/or as pulse trains, in the material so that a resulting modification zone elongated in a beam propagation direction enters the material and penetrates at least one surface of the material. Each pulse train comprises multiple sub-laser pulses, The method further includes introducing a plurality of material modifications along a severing line into the material via the laser pulses, and severing the material along the severing line, A pulse energy of the individual laser pulses or a sum of pulse energies of the sub-laser pulses is in a range from 500 μJ to 50 mJ. A length of the modification zone in the beam propagation direction is greater than a thickness of the material.

### CROSS REFERENCE TO RELATED APPLICATIONS

This application is a continuation of International Application No. PCT/EP2021/080197 (WO 2022/122252 A1), filed on Oct. 29, 2021, and claims benefit to German Patent Application No. DE 10 2020 132 700.5, filed on Dec. 8, 2020. The aforementioned applications are hereby incorporated by reference herein.

### FIELD

Embodiments of the present invention relate to a method for severing an at least partially transparent material.

### BACKGROUND

In recent years, the development of lasers having very short pulse lengths, in particular having pulse lengths less than a nanosecond, and high average powers, in particular in the kilowatt range, has resulted in a novel type of material processing. The short pulse length and high pulse peak power or the high pulse energy of several hundred microjoules can result in nonlinear absorption of the pulse energy in the material, so that actually transparent or essentially transparent materials can also be processed for the laser light wavelength used.

A severing method is described in U.S. Ser. No. 10/421,683, which is based on introducing laser pulses into the material. Methods according to the prior art have the problem above all that in the case of thicker materials, in particular glasses or layered systems, having a material thickness of greater than 1 mm, good severability is only to be achieved with difficulty or not at all. Good severability is typically understood to mean that a material can be reliably severed along a specified severing line.

### SUMMARY

Embodiments of the present invention provide a method for severing an at least partially transparent material. The method includes focusing ultrashort laser pulses, as individual laser pulses and/or as pulse trains, in the material so that a resulting modification zone elongated in a beam propagation direction enters the material and penetrates at least one surface of the material. Each pulse train comprises multiple sub-laser pulses, The method further includes introducing a plurality of material modifications along a severing line into the material via the laser pulses, and severing the material along the severing line, A pulse energy of the individual laser pulses or a sum of pulse energies of the sub-laser pulses is in a range from 500 μJ to 50 mJ. A length of the modification zone in the beam propagation direction is greater than a thickness of the material.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIGS. 1A, 1B, and 1C show a schematic representation of carrying out the method according to some embodiments;

FIGS. 2A and 2B show a microscope image and cross section of a material modification with material ejection according to an embodiment;

FIGS. 3A, 3B, 3C, 3D, 3E, and 3F show a schematic representation of beam cross sections of quasi-non-diffracting beams according to some embodiments;

FIGS. 4A, 4B, 4C, and 4D show an analysis of the beam cross section of quasi-non-diffracting beams according some embodiments;

FIG. 5 shows a schematic representation of a compound elliptical quasi-non-diffracting beam according to an embodiment;

FIGS. 6A, 6B, and 6C show a further schematic representation of carrying out the method according to some embodiments;

FIGS. 7A, 7B, 7C, and 7D show schematic representations of elliptical beam cross sections and material modifications, and the alignment thereof along a severing line, according to some embodiments;

FIGS. 8A and 8B show a schematic representation of the device for carrying out the method according to some embodiments;

FIGS. 9A and 9B show a schematic representation of carrying out the method according to some embodiments; and

FIG. 10 shows microscope pictures of material modifications generated according to the method according to some embodiments.

### DETAILED DESCRIPTION

Embodiments of the present invention provide a method for severing an at least partially transparent material. Ultrashort laser pulses in the form of individual laser pulses and/or in the form of pulse trains, which comprise multiple sub-laser pulses, are focused in the material so that the resulting modification zone, which is elongated in the beam propagation direction, enters the material and penetrates at least one surface of the material, wherein material modifications are thus introduced into the material, wherein a plurality of material modifications are introduced along a severing line into the material, and wherein the material is subsequently severed by means of a severing cut along the severing line. According to embodiments of the invention, the pulse energy of the individual laser pulses or the sum of the pulse energies of the sub-laser pulses is in a range from 500 μJ to 50 mJ.

The material can be a metal or a semiconductor or an insulator or a combination thereof. It can also be a glass, a glass ceramic, a polymer, or a semiconductor wafer, for example a silicon wafer. The material can also be a glass substrate and/or a stacked substrate system and/or a silicon wafer. The thickness L_{M} of the material is preferably greater than 1 mm.

The material is partially transparent to the wavelength of the laser in this case, wherein partially transparent means that typically 50% or more of the incident light of this wavelength is transmitted through the material.

The ultrashort pulse laser provides ultrashort laser pulses in this case. Ultrashort in this case can mean that the pulse length is, for example, between 500 ps and 1 fs, or between 100 ps and 10 fs. The ultrashort pulse laser can also provide pulse trains (so-called bursts) made up of ultrashort laser pulses, wherein each pulse train comprises the emission of multiple sub-laser pulses. The time interval of the sub-laser pulses can in this case be between 10 ps and 500 ns, or between 10 ns and 80 ns. An ultrashort laser pulse is also viewed as a chronologically formed pulse which has a noteworthy change of the amplitude within a range between 50 fs and 5 ps. The term pulse or laser pulse is used repeatedly in the following text. In this case, chronologically shaped laser pulses are also included, even if this is not explicitly mentioned in each case. The ultrashort laser pulses emitted by the ultrashort pulse laser accordingly form a laser beam.

The laser beam is focused in the material so that the laser beam includes an elongated focus zone in the beam propagation direction. This can mean that the focus zone of the laser beam in the beam propagation direction is greater than the extension of the laser beam perpendicular to the beam propagation direction. A general definition for the extension of the focus zone is given below.

In contrast, the elongated modification zone describes the area of the laser beam in which the intensity is above the processing threshold of the material, so that material processing can take place within the modification zone of the laser. The geometric shape of the modification zone of the laser and the focus zone are linked to one another in this case by the scaling using the laser intensity.

The elongated modification zone can penetrate at least one surface. This can mean that a surface of the material intersects the elongated modification zone. The intensity of the laser beam is thus greater on this surface than on the surface which is not penetrated by the elongated modification zone. Thus, it is possible that the laser beam emits the pulse energy into the volume of the material.

The elongated modification zone can also penetrate more than one surface. Two opposing surfaces can thus also be penetrated by the elongated modification zone, so that a quasi-homogeneous intensity distribution by the laser exists between the two surfaces.

The laser pulse or the laser pulses are at least partially absorbed by the material, so that the material heats up locally or enters a temporary plasma-type state. The absorption can be based in this case on linear or nonlinear absorption. The size of the processed area is determined here by the beam geometry, in particular by the modification zone of the laser beam and the beam cross section. A material modification can be generated by the modification zone elongated in the beam propagation direction which can reach, for example, over the entire thickness of the material.

Such a material modification over the entire material thickness can be generated directly, for example, using a single pulse or a single laser pulse train of sub-laser pulses. The material modifications are thus introduced into the material by the local action of the laser.

The material modification can in this case in general be a modification of the structure, in particular the crystalline structure and/or the amorphous structure and/or the mechanical structure, of the material. For example, an introduced material modification of an amorphous material can be that the material receives a changed network structure due to local heating only in this area. For example, the bond angles and lengths of the network structure can be changed by the modification. A material modification can in particular be a local density change, which can also comprise areas without material, which can also be dependent on the selected material.

In dependence on the specific material properties and the specific settings of the laser, such as pulse energy, pulse duration, and repetition rate, furthermore other types of material modifications can also occur. For example, the laser can provide a laser beam at a first setting, which results in an isotropic index of refraction change in the material. The laser can also however provide a laser beam at a further setting, which results in a birefringent index of refraction change in the material, so that the material has local birefringent properties.

In particular at high pulse energies, so-called micro-explosions can occur, in the case of which highly excited, then gaseous material is pressed out of the focus zone into the surrounding material and a less dense area or an empty core having surrounding compacted material results. The size of the heated area is determined here by the beam geometry, in particular by the modification zone of the laser beam and the beam cross section.

In contrast to the material modification, the material modification area comprises the entire area here in which the effects of the action of the laser pulse are measurable, for example, on the basis of the tensile and compressive stresses. This is in particular the area in which the material, viewed spatially starting from the material modification, merges back into the starting state of the untreated areas of the material.

Due to the temperature gradients which arise due to the local pulse action, stresses, which promote cracking, can occur in the material modification area upon the heating and/or upon the cooling and formation of the material modification. In particular, tensile and also compressive stresses can arise in the material modification area, which extend radially or ortho-radially, for example. A material modification is therefore preferably accompanied by indexed cracking, thus targeted damage to the material.

As a function of the selected pulse energy, the material modification can generate material ejections at a surface of the material. The material ejections are a measure in this case of the quality of the material modifications and thus also of the severability of the material.

Material ejections are in this case material accumulations on a surface of the material, which arise around the location at which the laser pulses are introduced to generate a material modification. In particular “a surface” means that it can be both the upper side and the lower side of the material relative to the beam propagation direction here. Material ejections are a result of the heating of the material, which penetrates out of the volume of the material upon the introduction of the laser pulses. However, a part of the volume can also be lost by vaporization, etc., so that there does not have to be accurate correspondence of the material volumes displaced from the material and the material volumes deposited around the material modification in the material ejections.

The material modifications are introduced into the material along a desired severing line. A severing line describes in this case that line along which the material or parts of the material are to be severed or cut off.

The material is quasi-perforated by the introduced material modifications along a severing line in the material, so that a type of predetermined breaking point in the material is defined by the severing line. This perforation generally does not result in independent severing of the material, however. Rather, the material modifications along the severing line ensure, for example, material weakening, so that upon application of a following severing step, for example by application of a thermal stress and/or by application of a mechanical stress, preferably a tensile or bending stress, and/or by etching by means of at least one wet-chemical solution, severing takes place along the severing line.

The pulse energy of the individual laser pulses or the sum of the pulse energies of the sub-laser pulses is in a range from 500 μJ to 50 mJ. In this way, a good severability is achieved above all in thick materials, for example having a material thickness of greater than 1 mm.

The severing step can comprise the application of a thermal stress along the severing line and/or the application of a mechanical stress, preferably a tensile or bending stress, and/or etching by means of at least one wet-chemical solution.

A thermal stress can be achieved, for example, by heating the material along the severing line. For example, the severing line can be heated by means of a continuous wave CO2 laser, so that the material in the material modification area expands differently in comparison to the untreated or non-heated material. The cracks promoted by the material modification thus experience a crack growth, so that a continuous and non-interlocked severing surface can form, by which the parts of the material are separated from one another.

A tensile or bending stress can be generated, for example, by the application of a mechanical load to the material parts separated by the severing line. For example, a tensile stress can be applied when forces opposing in the material plane act on the material parts separated by the severing line at a force engagement point in each case, each of which points away from the severing line. The forces are thus not aligned in parallel or antiparallel to one another, so that this can contribute to the occurrence of a bending stress. As soon as the tensile or bending stresses are greater than the bonding forces of the material along the severing line, the material is severed along the severing line.

The material can also be severed by etching using a wet-chemical solution, wherein the etching process preferably attacks the material at the material modification, thus the targeted material weakening. In that the material parts weakened by the material modification are preferably etched, this results in severing of the material along the severing line.

This has the advantage that an ideal severing method can be selected for the respective material, so that severing of the material is accompanied by a high quality of the severed edge.

The laser pulses can have a wavelength between 0.3 μm and 1.5 μm, and/or the pulse length of the individual laser pulses and/or the sub-laser pulses can be 0.01 ps to 50 ps, preferably 0.3-15 ps, and/or the average power of the laser at the laser output can be between 150 W and 15 kW.

This has the advantage that the method can be optimized for the respective material over a large parameter range. In particular, this increases the probability of finding a laser wavelength available for a material, at which the material is partially transparent.

The laser beam formed by the laser pulses and the material can be displaceable relative to one another with a feed in order to introduce the plurality of the material modifications along the severing line into the material, wherein the laser beam and the material are preferably alignable in relation to one another at an angle, in particular tiltable and/or rotatable.

Displaceable relative to one another means both that the laser beam can be translationally displaced relative to a stationary material, and the material can also be displaced relative to the laser beam, or a movement takes place of both the material and the laser beam.

In particular, the focus of the laser beam can thus be placed at various locations of the material in order to introduce material modifications. In addition to translational movements along the X, Y, and Z axes, rotational movements are also possible in particular, in particular rotations of the material around the beam propagation direction. This can comprise rotations around all Euler angles.

It is thus possible to orient the laser beam along the severing line.

In one preferred embodiment, the elongated modification zone is longer in the beam propagation direction than the material thickness L_{M}, in particular longer than 1.5×L_{M} or longer than (2×200 μm)+L_{M}.

In that the elongated modification zone is longer than the material thickness, the material modification can be introduced over the entire material thickness. In particular, a large focus location tolerance can also be achieved, so that material thickness variations or material irregularities, in particular in large-format glass substrates having a size of greater than 1 m², can be neglected. However, it is to be noted that the required pulse energy for introducing a material modification rises linearly with the length of the focus zone.

The maximum diameter of the beam cross section perpendicular to the beam propagation direction in the modification zone can be between 1 μm and 50 μm, preferably between 2 μm and 4 μm.

In particular material modifications having a large lateral extension can thus be generated, so that the severability of the material is improved.

The laser beam formed by the laser pulses can, at least in the elongated focus zone, be a quasi-non-diffracting beam or a coherent superposition of at least two quasi-non-diffracting beams.

Non-diffracting beams satisfy the Helmholtz equation:

∇²U(x,y,z)+k²U(X,y,Z)=0

and have a clear separability into a transverse and a longitudinal dependence of the form

U(x,y,z)=Uₜ(x,y)exp(ik_{z}z).

In this case, k=ω/c is the wave vector having its transverse and longitudinal components k²=k_{z}²+kₜ² and Uₜ(x,y) is an arbitrary complex-valued function, which is only dependent on the transverse coordinates x,y. The z dependence in the beam propagation direction in U(x,y,z) results solely in a phase modulation, so that the associated intensity I of the solution is propagation invariant or non-diffracting:

I(x,y,z)=|U(x,y,z)|²=I(x,y).

This approach provides various solution classes in different coordinate systems, such as Mathieu beams in elliptical-cylindrical coordinates or Bessel beams in circular-cylindrical coordinates.

A plurality of non-diffracting beams may be experimentally implemented in good approximation, thus quasi-non-diffracting beams. In contrast to the theoretical construct, these only conduct a finite power. The length L of the propagation invariance of these quasi-non-diffracting beams is also finite.

Based on the norm for laser beam characterization ISO11146 1-3, the beam diameter is determined via the so-called second moments. The power of the laser beam or also the zero-order moment is defined in this case as:

P=∫dx dy I(x,y).

The first-order spatial moments indicate the focal point of the intensity distribution and are defined as:

$$〈 x 〉 = \frac{1}{P} \int dxdyxI ( x , y ) ,$$

$$〈 y 〉 = \frac{1}{P} \int dxdyyI ( x , y ) .$$

Based on the above equations, the second-order spatial moments of the transverse intensity distribution may be calculated:

$$〈 {x}^{2} 〉 = \frac{1}{P} \int {dxdy ( x - 〈 x 〉 )}^{2} I ( x , y ) ,$$

$$〈 {y}^{2} 〉 = \frac{1}{P} \int {dxdy ( y - 〈 y 〉 )}^{2} I ( x , y ) ,$$

$$〈 xy 〉 = \frac{1}{P} \int dxdy ( x - 〈 x 〉 ) ( y - 〈 y 〉 ) I ( x , y ) .$$

The beam diameter or the size of the focus zone in the main axes may be determined using the second-order spatial moments of the laser beam thus completely defined. The main axes are in this case the directions of the minimum and maximum extension of the transverse beam profile, thus the intensity distribution perpendicular to the beam propagation direction, which always extend orthogonally to one another. The focus zone d of the laser beam then results as follows:

$${d}_{x} = 2 \sqrt{2} {\{ ( 〈 {x}^{2} 〉 + 〈 {y}^{2} 〉 ) + {γ [ {( 〈 {x}^{2} 〉 - 〈 {y}^{2} 〉 )}^{2} + 4 {( 〈 xy 〉 )}^{2} ]}^{\frac{1}{2}} \}}^{\frac{1}{2}} ,$$

$${d}_{y} = 2 \sqrt{2} {\{ ( 〈 {x}^{2} 〉 + 〈 {y}^{2} 〉 ) - {γ [ {( 〈 {x}^{2} 〉 - 〈 {y}^{2} 〉 )}^{2} + 4 {( 〈 xy 〉 )}^{2} ]}^{\frac{1}{2}} \}}^{\frac{1}{2}} ,$$

$$with$$

$$γ = \frac{〈 {x}^{2} 〉 - 〈 {y}^{2} 〉}{\vert 〈 {x}^{2} 〉 - 〈 {y}^{2} 〉 \vert} .$$

In particular, a long and a short main axis of the transverse focus zone result by way of the values dₓ and d_{y}.

The focus zone of a Gaussian beam is thus defined via the second moments of the beam. In particular, the size of the transverse focus zone d^{GF}_{x,y} and the longitudinal extension of the focus zone, the Rayleigh length z_{R}, result therefrom. The Rayleigh length z_{R} is given by z_{R}=π(d^{GF}_{x,y})²/4λ. It describes the distance along the beam propagation direction starting from the position of the intensity maximum, at which the area of the focus zone has increased by the factor of 2. In the case of a symmetrical Gaussian beam, the following applies for the focus zone: d^{GF}₀=d^{GF}ₓ=d^{GF}_{y}.

Furthermore, we define as the transverse focus diameter in quasi-non-diffracting beams d^{ND}₀ the transverse dimensions of local intensity maxima as twice the shortest distance between an intensity maximum and an intensity drop to 25% starting therefrom.

The focus zone of the quasi-non-diffracting beams is also defined via the second moments of the beam. In particular, the focus zone results from the size of the transverse focus zone d^{ND}_{x,y} and the longitudinal extension of the focus zone, the so-called characteristic length L. The characteristic length L of the quasi-non-diffracting beam is defined via the intensity drop to 50%, starting from the local intensity maximum, along the beam propagation direction. In particular, the size of the focus zone is normed as shown above to the total laser power and is thus independent of the maximum power which is transported by the beam.

A quasi-non-diffracting beam exists precisely when d^{ND}_{x,y}≈d^{GF}_{x,y}, thus similar transverse dimensions which significantly exceed the characteristic length L of the Rayleigh length of the associated Gaussian focus, for example, if L>10z_{R}.

Quasi-Bessel beams or Bessel-like beams, also called Bessel beams here, are known as a subset of the quasi-non-diffracting beams. In this case, the transverse field distribution Uₜ(x,y) in the vicinity of the optical axis obeys in good approximation a Bessel function of the first type of the nth order. A further subset of this class of beams is represented by the Bessel-Gauss beams, which are widespread due to their simple generation. The illumination of an axicon in refractive, diffractive, or reflective embodiment using a collimated Gaussian beam thus permits the formation of the Bessel-Gauss beam. The associated transverse field distribution in the vicinity of the optical axis obeys in good approximation a zero-order Bessel function of the first type, which is enclosed by a Gaussian distribution.

Accordingly, it can be advantageous to use a quasi-non-diffracting beam, in particular a Bessel beam, to process a material, since a large focus location tolerance can be achieved in this way.

Typical Bessel-Gauss beams for processing a material have, for example, a d^{ND}_{x,y}=2.5 large transverse focus zone, whereas the characteristic length can be 50 For a Gaussian beam having a d^{GF}_{x,y}=2.5 μm large transverse focus zone, the Rayleigh length in air can only be z_{R}≈μm at λ=1 μm, however. In these cases relevant for material processing, accordingly L>>10z_{R} can apply.

A coherent superposition of the quasi-non-diffracting radiation results in particular by superposition of at least two quasi-non-diffracting beams. It is thus possible to generate further beam profiles and thus forms of the material modifications.

The laser beam can have a non-radially symmetric beam cross section perpendicular to the beam propagation direction, wherein the beam cross section or the envelope of the beam cross section is preferably elliptical in shape.

Non-radially symmetric in this case means, for example, that the transverse focus zone is stretched in one direction. A non-radially symmetric focus zone can also mean, however, that the focus zone is, for example, cross-shaped or is triangular or N-polygonal, for example pentagonal. A non-radially symmetric focus zone can moreover comprise further rotationally symmetric and mirror-symmetric beam cross sections.

For example, an elliptical focus zone can exist perpendicularly to the propagation direction, wherein the ellipse has a long axis dₓ and a short axis d_{y}. An elliptical focus zone thus exists when the ratio dₓ/d_{y} is greater than 1, in particular is dₓ/d_{y}=1.5. The elliptical focus zone of the specific existing beam can correspond to an ideal mathematical ellipse. The present specific focus zone of the quasi-non-diffracting beam can also only have the above-mentioned ratios of long main axis and short main axis, however, but a different contour—for example an approximated mathematical ellipse, a dumbbell shape, or another symmetrical or asymmetrical contour, which is enclosed by a mathematically ideal ellipse.

In particular, elliptical quasi-non-diffracting beams may be generated via quasi-non-diffracting beams. Elliptical quasi-non-diffracting beams have special properties in this case, which result from the analysis of the beam intensity. For example, elliptical quasi-non-diffracting beams have a main maximum which coincides with the center of the beam. The center of the beam is given in this case by the location at which the main axes intersect. In particular, elliptical quasi-non-diffracting beams can result from the superposition of multiple intensity maxima, wherein in this case only the envelope of the participating intensity maxima is elliptical. In particular, the individual intensity maxima do not have to have an elliptical intensity profile.

The secondary maxima closest to the main maximum, which result from the solution of the Helmholtz equation, have in this case a relative intensity of greater than 17%. Therefore—depending on the transported laser energy in the main maximum, enough laser energy is also conducted in the secondary maxima that material processing is enabled. Moreover, the closest secondary maxima always lie on a straight line which is perpendicular to the long main axis, or is parallel to the short main axis, and extends through the main maximum.

In particular, the contours of the beam cross sections have locations having different curve radii. For example, in an elliptical beam cross section, the curve radius at the point at which the small half-axis intersects the ellipse is particularly large, while the curve radius at the point at which the large half-axis intersects the ellipse is particularly small. For example, the possibility can result for material stresses to relax at the points of small curve radii, for example peaks and corners, so that induced cracking occurs there. It is possible to improve the severability of the material along the severing line by a controlled crack propagation between the material modifications.

The long axis of the non-radially symmetric beam cross section can be oriented perpendicular to the beam propagation direction along the severing line and/or along the feed direction.

Cracking typically takes place along a preferred direction of the non-radially symmetric beam cross section—for example, crack propagation primarily takes place in the direction of a longer extension of the beam cross section, which is accompanied by smaller radii of the contour of the beam cross section at the outer contour edges located in this preferred direction.

In particular, targeted crack guidance can be promoted by a rotation of the non-radially symmetric beam cross section and/or the material, so that a preferred direction of the non-radially symmetric beam cross section is always oriented along the severing line due to the rotation.

If the feed direction between laser beam and material is aligned, for example, perpendicular to an axis along which a preferred crack propagation takes place, meeting of the cracks of adjacent material modifications is then improbable. If the feed direction is aligned in parallel to the axis of the preferred crack propagation, in contrast, it is then probable that the cracks of adjacent material modifications will meet and unite. Targeted crack guidance over the entire length of the severing line can thus also be ensured by the rotation of the beam cross section and/or the workpiece with curved severing lines. It is thus possible to sever the material along arbitrarily shaped severing lines.

The long axis of the non-radially symmetric beam cross section can have a negligible or non-negligible intensity and can preferably have an interference contrast of less than 0.9 in the case of the non-negligible intensity.

An elliptical quasi-non-diffracting beam can have a non-negligible intensity along the long main axis in this case, in particular can have an interference contrast Iₘₐₓ−Iₘᵢₙ/(Iₘₐₓ+Iₘᵢₙ)<0.9, so that the beam transports laser energy everywhere along the long main axis.

Iₘₐₓ is in this case the maximum beam intensity along the long main axis, while Iₘᵢₙ is the minimum beam intensity. If Iₘᵢₙ=0, then complete interference occurs along the long main axis and an interference contrast of 1 results. If Iₘᵢₙ>0, then only partial or no interference occurs along the long main axis, so that the interference contrast is <1.

If, for example, the interference contrast along the long main axis is less than 0.9, complete interference does not occur along the long main axis, but only partial interference, which does not result in complete cancellation of the laser intensity at the location of the intensity minimum Iₘᵢₙ. This is the case, for example, if the quasi-non-diffracting beam is generated using a birefringent element, for example a quartz angle displacer or a quartz beam displacer or a combination thereof.

An elliptical quasi-non-diffracting beam can also have a negligible intensity and an interference contrast of 1 along the long main axis, however, so that the beam does not transport laser energy everywhere along the long main axis. This is the case, for example, if the quasi-non-diffracting beam is generated using a modified axicon.

The laser beam formed by the laser pulses can be incident on the material surface at a processing angle which is preferably not a right angle, wherein the processing angle is less than 20° for material thicknesses less than 2 mm and is less than 10°, in particular less than 5°, for material thicknesses greater than 2 mm.

In that the laser beam is incident at an angle on the material surface, the laser beam experiences a refraction upon entering the material. Accordingly, the material modification is not introduced perpendicularly to the surface, but rather at a refraction angle which is determined according to Snell's law of refraction. In this way, it is possible for the material not to have edges which are shaped at a right angle. For example, beveled edges can be generated along which materials can be assembled again and joined, for example. For example, lateral joining of materials to one another can thus be achieved.

In particular, the processing angle of the modification zone in the material, in which good severability is still achieved, is dependent on the material thickness.

The individual laser pulses and/or pulse trains can be triggered by a position-controlled pulse triggering of the laser system, wherein the position is preferably provided by the position of the laser beam formed by the laser pulses on the material.

A position-controlled pulse triggering can be implemented via a detector, which reads the location of the material or the feed device or the feed vector and the position of the laser beam.

It is thus possible for material modifications to be introduced into the material along the severing line at equal intervals. It is thus possible in particular to prevent material modifications from overlapping, as can occur with a constant laser pulse rate and varying feed speed.

Preferred exemplary embodiments are described hereinafter on the basis of the figures. Identical, similar, or identically acting elements are provided with identical reference signs in the different figures and a repeated description of these elements is partially omitted to avoid redundancies.

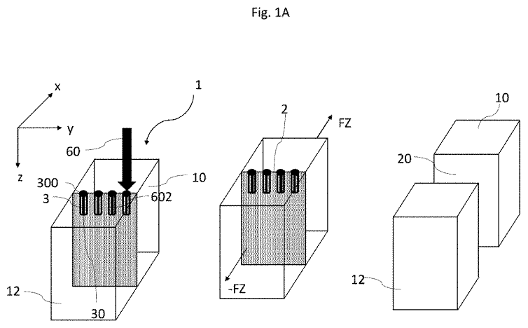

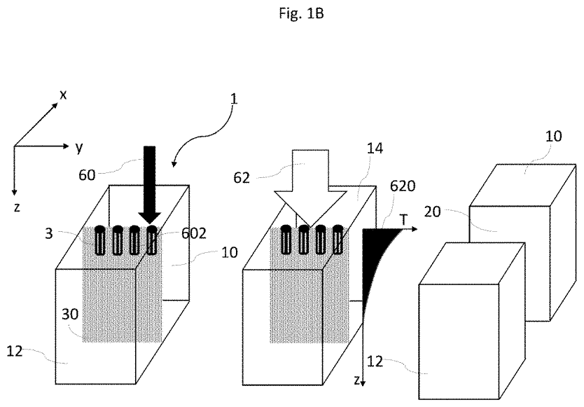

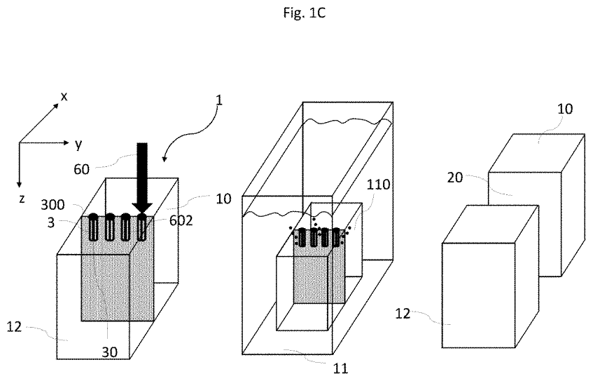

FIG. 1 schematically shows the severing method described here for severing an at least partially transparent material 1.

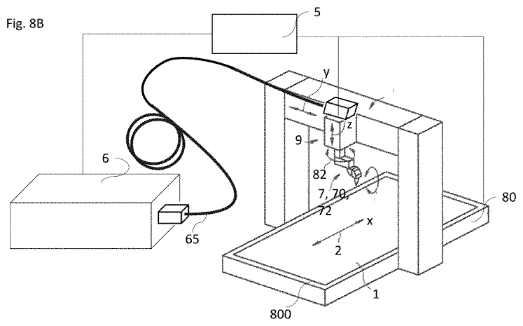

To sever the material 1, laser pulses of an ultrashort pulse laser 6 (see FIG. 8A, for example) are focused in the material 1. The laser pulses run in the laser beam 60, which are absorbed at least partially by the material 1 in the modification zone 602 of the laser beam 60, in order to introduce a material modification 3 into the material 1 in this way. The shaded plane in this case shows the plane below the severing line 2, along which the material 1 is severed. Ideally, this plane corresponds to the later severing surface 20.

Material modifications 3 can be generated due to the linear and/or nonlinear absorption of the laser pulses in the material 1. For example, the general structure of the material 1 or the density of the material can thus be changed in order to form the material modifications 3 in this way.

However, it is also possible that so-called micro-explosions occur due to the absorption of the laser pulses, in which the material 1 is suddenly vaporized in the modification zone 602 of the laser beam. The highly excited, then gaseous material 1 is moved into the surrounding material 1 by the high pressure, so that the material 1 is compacted at the shock front. A less dense or empty core (“void”), which is surrounded by the compacted material, thus arises in the area of the modification zone 602. In particular, a part of the material can also penetrate outward from the modification zone 602 due to the micro-explosions, where it is deposited on the surface of the material 1 and forms material ejections 300.

These modifications result in the material modification 3. A material modification area 30 is formed around the material modification 3. In the material modification area 30, the material gradually passes from the state which is present in the material modification 3 back into its original state, the farther away the material is observed from the material modification 3. The original state can be, for example, the unprocessed state of the material, which is present in adjacent points in the material 1, for example. The original state is also understood here, however, as the state of the material 1 which was present before the introduction of the material modification 3.

The laser pulses can have a wavelength between 0.3 μm and 1.5 μm and/or the pulse length of the laser pulses can be 0.01 ps to 50 ps, preferably can be 0.3-15 ps, and/or the average power of the laser can be 150 W to 15 kW. The laser energy can be introduced in the form of individual laser pulses into the material, wherein the repetition rate of the individual laser pulses is 1 kHz to 2 MHz. However, the laser energy can also be introduced into the material in the form of pulse trains, comprising multiple sub-laser pulses, wherein the repetition frequency of the sub-laser pulses of the pulse train can be between 2 MHz and 100 GHz, in particular 12.5 MHz to 100 MHz, furthermore wherein a pulse train can preferably comprise 2 to 20 sub-laser pulses and/or the sum of the pulse energies of the sub-laser pulses of a pulse train can be between 500 μJ and 50 mJ.

For example, a material modification 3 can be generated using a laser having 1 μm wavelength, a pulse duration of 1 ps, and an average power of 1000 W. The laser pulse can be introduced in the form of an individual pulse into the material 1, wherein the repetition rate of the laser is, for example, 100 kHz.

Local stresses can occur in the material modification 3 and the material modification area 30, which promote cracking. For example, the material 1 can have a different density—for example a lower density—due to local heating and can thus build up a compressive stress in the material modification area 30. However, a higher density can also exist in the heated area and a tensile stress can thus be built up in the material modification area 30. If the tensile and/or compressive stress becomes excessively large, for example greater than the tensile or compressive strength of the untreated material, a crack can form spontaneously.

As shown in FIG. 1, multiple material modifications 3 are introduced into the material 1. Material modification areas 30 form around each material modification 3. The placement of the material modifications 3 takes place in this case along the desired severing line 2. The severing line 2 is an imaginary line along which the material 1 is to be severed.

The material 1 is quasi-perforated by the introduced material modifications 3 along the severing line 2 in the material 1, so that a type of predetermined breaking point in the material 1 is defined by the severing line 2. This perforation generally does not result in independent severing of the material 1, however. Rather, the material modifications 3 along the severing line 2 ensure, for example, targeted material weakening and/or a targeted introduction of cracks 32, which induce material weakening along the severing line 2.

After the material modifications 3 are introduced into the material 1 by means of the laser beam 6, for example, in a following severing step, the material 1 can be physically severed by applying a tensile force FZ to the material halves 10 and 12 separated from one another by the severing line 2. In particular, it is also possible to sever the material 1 by applying a bending stress to the material halves 10, 12 (not shown).

FIG. 1B shows an analogous method, in which the material halves are not severed using a mechanical force in a severing step, but rather by applying a thermal stress.

After the material modifications 3 have been introduced, a thermal gradient 620 can be generated via the material modifications 3. A continuous wave CO2 laser 62, for example, can be used to introduce the thermal gradient 620.

The focus of the continuous wave CO2 laser 62 can be placed, for example, a few micrometers below the surface 14 to generate the thermal gradient 620, so that the severing of the material 1 runs with little damage and a smooth fracture edge or severing surface 20 results. However, the focus can also be positioned at a different distance to the surface. In general, a large part of the continuous wave CO2 laser radiation is already absorbed a few nanometers below the surface of the material, so that there is at least no strong dependence on the positioning of the focus of the continuous wave CO2 laser 62.

Due to the dominant absorption in the vicinity of the upper surface 14 of the material, the temperature is greater there than at the lower surface. A thermal gradient T(z) thus results. Due to the thermal expansion of the material 1, which is linearly dependent on the temperature in a first approximation, the material 1 expands more strongly at the upper surface 14 than at the lower surface. Material stresses of different strengths thus occur along the Z axis.

The various material stresses run through the introduced material modifications 3. Material stresses can preferably relax there, which results in cracking. The cracking takes place between the various adjacent material modifications 3. Cracking thus occurs which ultimately severs the material 1 into the two material halves 10 and 12.

FIG. 1C shows a further analogous method, in which the material halves 10, 12 are severed in a severing step by means of a wet-chemical reaction. For this purpose, the material 1 perforated using the material modifications 3 is put into a chemical bath 11. The chemical bath 11 contains in this case a solvent which is capable of removing and etching the material 1. In particular, the etching procedure takes place in the previously introduced material modifications 3, since the material weakening is particularly large there and the change of the physical and/or chemical properties at the location of the material modification 3 causes the reaction to run particularly advantageously. A material modification 3 can in a certain sense act as a catalyst of the etching reaction. The reaction is schematically indicated in FIG. 1C by the occurrence of reaction bubbles 110 in the chemical bath 11.

As soon as the material 1 is etched through, the material 1 is severed into two material halves 10, 12. If the material 1 is not yet severed after the chemical bath 11, for example since the chemical bath 11 has exclusively etched away the material modifications 3, the material 1 has thus been deliberately damaged further along the severing line 2, so that the material 1 can be severed into the material halves 10, 12 by applying a tensile or bending stress, for example.

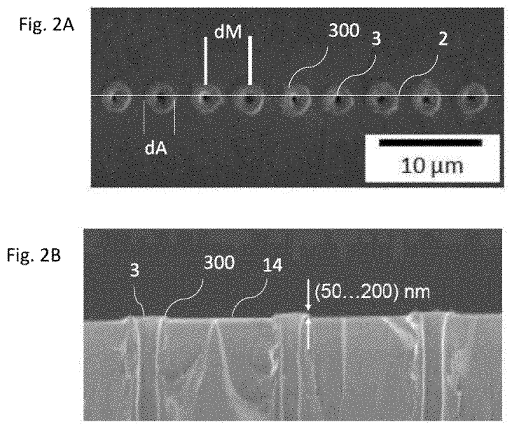

FIG. 2A shows a microscope image of the surface of a processed material 1. Round material modifications 3 were introduced into the material 1 along the severing line 2 at an interval dM=5 μm. The material modifications 3 have the shape of a perforated channel, wherein the material of the outer lateral surface of the perforated channel was compacted by micro-explosions during the introduction of the material modification 3. Round material ejections 300 result on the surface of the material 1 around the round opening of the material modification 3 or the perforated channel. These material ejections 300 have an external diameter dA. The external diameter of the material ejections 300 is 3 μm here.

FIG. 2B shows a thickness cross section through FIG. 2A. It can be seen clearly that the material ejections have a height above the surface of the material 1 of 50 nm to 200 nm. The diameter and the height of the material ejections 300 are specified in this case by the pulse energy and the beam cross section of the laser beam. It is apparent in particular that the material modification 3 begins at the upper surface 14. This is a result of the elongated modification zone 602 penetrating the surface 14, thus in particular that there is a common intersection surface.

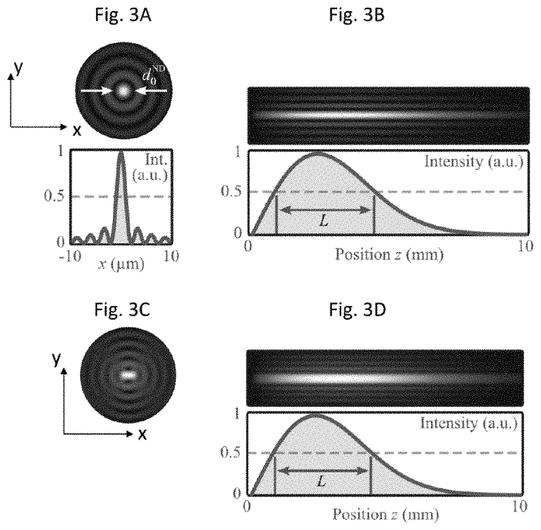

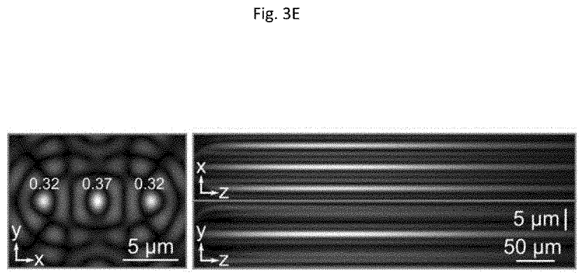

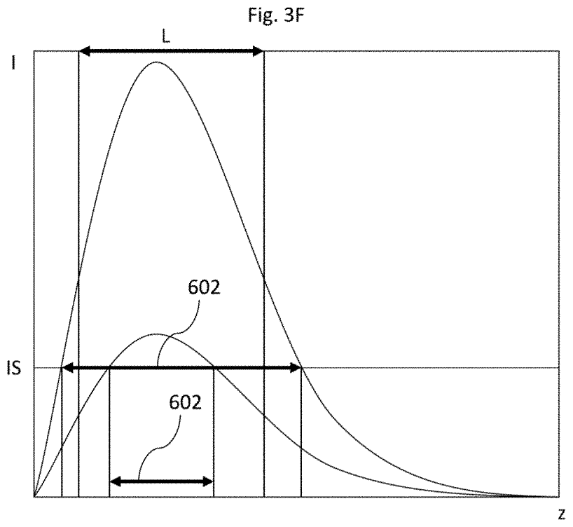

FIG. 3A shows the intensity curve and beam cross section 4 of a quasi-non-diffracting laser beam. In particular, the quasi-non-diffracting laser beam is a Bessel-Gauss beam. The Bessel-Gauss beam has a radial symmetry in the beam cross section 4 in the x-y plane, so that the intensity of the laser beam is only dependent on the distance to the optical axis. In particular, the transverse beam diameter d^{ND}_{x,y} is between 0.25 μm and 10 μm in size.

FIG. 3B shows the longitudinal beam cross section 4, thus the beam cross section 4 in the beam propagation direction. The beam cross section 4 has an elongated focus zone, which is approximately 3 mm in size. The focus zone is thus significantly larger in the propagation direction than the beam cross section 4, so that an elongated focus zone 600 is present.

FIG. 3C shows, similarly to FIG. 3A, a non-diffracting beam, which has a non-radially symmetric beam cross section 4. In particular, the beam cross section 4 appears stretched, nearly elliptical, in the y direction.

FIG. 3D shows the longitudinal focus zone 600 of the Bessel beam, which again has an extension of approximately 3 The Bessel beam also accordingly has an elongated focus zone in the beam propagation direction.

FIG. 3E shows a coherent superposition of various quasi-non-diffracting beams. Beam profiles, which could not be achieved using a single laser beam, can be generated by the superposition of multiple quasi-non-diffracting beams. The designations of the intensity maxima in the x-y plane indicate the rounded intensity distribution relative to the total intensity.

FIG. 3F shows the intensity curves of two laser beams having different laser power but having identical Gauss-Bessel-shaped beam cross section in the z direction. Both beam profiles have the same characteristic length L, since this is defined via the drop of the laser intensity to 50% of the intensity maximum. However, the material itself has a specific intensity threshold IS, from which processing of the material can take place. The length of the modification zone 602 is defined in this case as the length over which the intensity of the laser beam is above the intensity threshold IS of the material. A large modification zone 602 of the laser beam thus results for high laser powers, while the laser beam has a small modification zone 602 for low laser powers. The modification zone 602 of the laser beam thus scales with the transported laser power.

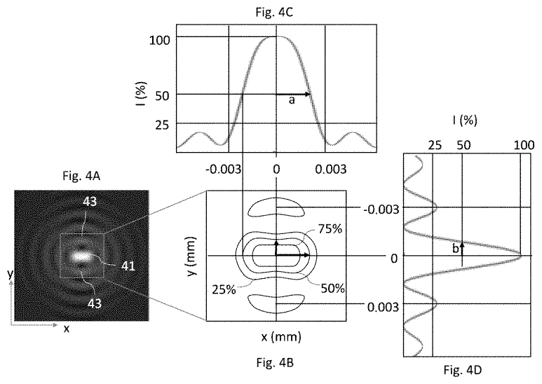

FIG. 4 shows a detailed analysis of the beam cross section 4 from FIG. 3C, D. FIG. 4A shows the transverse intensity distribution of the laser beam 60, wherein the main maximum and the secondary maxima result from the solution of the Helmholtz equation.

FIG. 4B shows the so-called iso-intensity lines of the intensity distribution from FIG. 4A, wherein the lines are drawn where the relative intensity of the laser beam is 25% or 50% or 75%. It is clearly visible that the main maximum 41 of the intensity distribution has an approximately elliptical shape, wherein the extension along the x axis is significantly greater than the extension along the y axis. In particular, the main maximum is adjoined by two kidney-shaped secondary maxima 43, which have a significantly lower relative intensity.

FIG. 4C shows a cross section through the intensity distribution from FIG. 4A through the center of the main maximum along the x axis. In the center of the main maximum 41, the intensity distribution has its maximum, wherein the relative intensity is at 100% here by definition. The intensity distribution drops along the positive and negative x direction until at approximately 0.003 mm, a minimum in the relative intensity distribution is reached, which is different from 0%, however. Accordingly, laser energy is also transported between the main maximum 41 and the secondary maxima 43 of the laser beam 60.

FIG. 4D shows a cross section through the intensity distribution from FIG. 4A through the center of the main maximum 41 along the y axis. However, the intensity maximum is again to be found here in the center, but the intensity drop along the y direction is significantly faster, so that the intensity minimum is reached at approximately 0.002 mm. The intensity minimum is exactly zero in this case, since complete interference exists for the laser beam 60 here. In particular, secondary maxima 43 are again to be found at larger values on the y axis, which are above a relative intensity value of 25%, for example. This is not the case in the x axis cross section from FIG. 4C. The properties of the elliptical beam cross section 4 therefore differ along the various propagation directions.

In particular, FIGS. 4C and 4B show that the long half-axis a is measured from the center of the main maximum to the drop of the relative intensity to 50%. Similarly, the length of the short half-axis b is measured from the center of the main maximum to the drop of the relative intensity to 50%. The long and short half-axes are perpendicular to one another in this case.

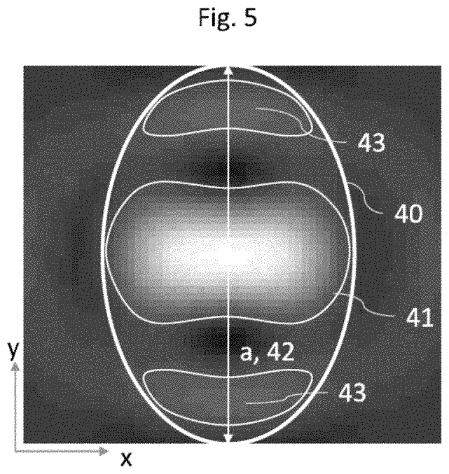

FIG. 5 shows that elliptical quasi-non-diffracting beams can result from the superposition of multiple intensity maxima, wherein in this case only the envelope of the participating intensity maxima is elliptical. In particular, the individual intensity maxima do not have to have an elliptical intensity profile.

In the present case, the beam cross section also has two kidney-shaped secondary maxima 43 in addition to the pronounced main maximum 41. Up to 17% of the laser energy of the main maximum 41 is transported in the secondary maxima. If the laser pulse energy is large enough, the laser pulse energy transported in the secondary maxima 43 is also sufficient to induce a material modification 3. The geometrical shape of the modification zone 602 can thus be influenced with the selection of the laser pulse energy.

For example, the laser pulse energy can be selected so that the areas above the 25% iso-intensity lines can already introduce material modifications. The main maximum 41 and the two secondary maxima 43 then each form, for example, overlapping material modification areas 30, so that overall an elliptical material modification 3 results, the long axis of which extends in the y direction. Cracking is thus also to be expected along the y direction.

In particular, an elliptical material modification 3 will also result due to this, the long axis of which is analogously aligned along the y axis.

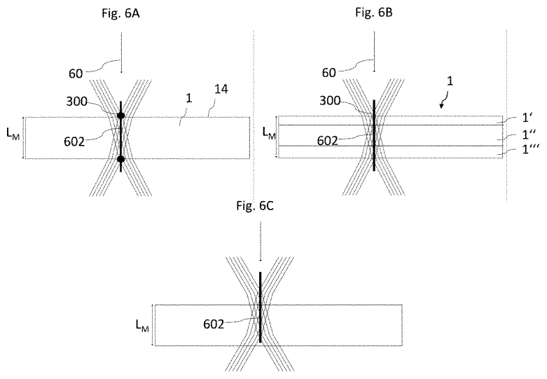

FIGS. 6A, B show that the elongated modification zone 602 can be introduced in different ways into the material 1. In FIG. 6A, the elongated modification zone 602 has a greater length than the material is thick. In particular, the elongated modification zone 602 is greater than 1.5×L_{M}. It is thus possible to position the modification zone 602 so that the modification zone 602 penetrates the upper surface 14 and the lower surface. It is thus possible in particular that the material modification 3 is introduced over the entire material thickness L_{M}. This results in a lower required severing force in the subsequent severing process and thus a lower surface roughness of the severing surface 20.

FIG. 6B shows that the material 1 can be constructed from various layers 1′, 1″, 1′″. Each layer has a separate material thickness in this case, wherein the total material thickness L_{M} is the sum of the thicknesses of the individual layers. In particular, each layer can also have an individual index of refraction, wherein each layer is partially transparent to the wavelength of the laser, however. The elongated modification zone 602 is also greater than the total material thickness here.

FIG. 6C shows that the elongated modification zone 602 can also be introduced into the material 1 so that only one material surface 14 is penetrated by the elongated modification zone 602. In the present case, the upper surface 14 is penetrated. However, it is also possible that other types of material modifications 3 are introduced into the material 1 by the laser beam 6.

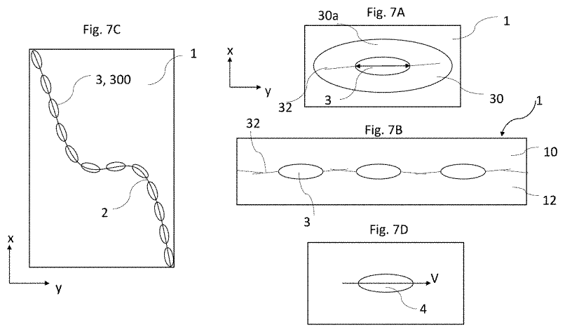

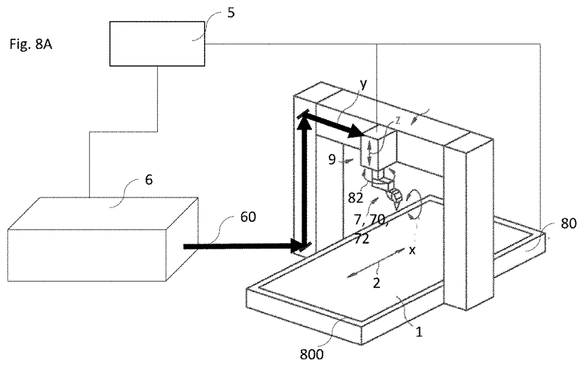

FIG. 7A shows an elliptical material modification 3 in a material 1. The material modification 3 is introduced by the laser beam 60 of the laser 6 into the material 1. The shape of the material modification 3 is specified in this case by the beam cross section 4 of the laser beam 60, in particular by its modification zone 602. Around the area of the material modification 3, in which a direct action of the laser beam 60 exists on the material 1 for the time of the laser pulse, a material modification area 30 is formed, which corresponds to the shape of the introduced material modification 3, or the beam cross section 4 of the laser beam 6.

Accordingly, material stresses can occur both in the material modification 3 itself and in the material modification area 30, which promote cracking. For example, with an elliptical material modification 3, cracking can be promoted at the points of the ellipse at which the curve radius of the boundary line is particularly small. It is ensured by a small curve radius that the stress which is introduced into the glass 1 by the material modification 3 can drop particularly quickly in many different directions. A relaxation of the material stress thus takes place with higher probability at this point than at locations where the material stress can relax in only a few directions. The points of the material modification 3 which have a small curve radius are thus particularly unstable in the material 1.

The formation of the crack 32 then preferably takes place in the direction of the long axis of the elliptical material modification 3. It is thus possible to control the crack propagation by way of the orientation of the material modification 3. It is thus possible in particular to control the crack propagation from one material modification 3 to another material modification 3.

In FIG. 7B, multiple material modifications 3 have been introduced into the material 1. The material modifications 3 are once again elliptical. The cracks 32 thus preferably form along the long axis of the ellipse at the points of the smallest curve radii of the ellipse. The material modifications 3 are placed so close to one another in the figure that the respective cracks of adjacent material modifications overlap. It is thus possible that the cracks merge and form a common crack between two adjacent material modifications. In particular, this state can be achieved by a crack growth, for example, by applying a tensile force. For example, cracks 32 can be introduced along arbitrary severing lines 2 in the material 1 by this method.

FIG. 7C shows that the long axes of the material modifications 3 and the material ejections 300 are aligned along the severing line 2. Since the long axes of the material modifications 3 are aligned along the severing line 2, this means at the same time that during the introduction of the material modifications 3, the long axis of the beam cross section of the laser beam 60 was aligned along the severing line 2.

FIG. 7D accordingly shows that the long axis of the beam cross section 4 is aligned in parallel to the feed speed V, so that the long axis is always aligned in parallel to the severing line 2.

FIG. 8A shows a structure for carrying out the method. The laser beam 60 of the ultrashort pulse laser 6 is deflected by a beamforming optical unit 9 and an optional mirror 70 onto the material 1. The material 1 is arranged in this case on a support surface of the feed device, wherein the support surface preferably neither reflects nor absorbs nor strongly scatters back into the material 1 the laser energy which the material does not absorb.

In particular, the laser beam 60 can be coupled by a free space section having a lens and mirror system into the beamforming optical unit 9. The laser can also however be coupled by a hollow core fibre 65 having coupling and decoupling optical units into the beamforming optical unit, as shown in FIG. 8B.

The beamforming optical unit 9 can be, for example, a diffractive optical element or an axicon, which generates a non-diffracting laser beam 60 from a Gaussian laser beam 60. In the present example, the laser beam 60 is deflected by the mirror 70 in the direction of the material 1 and focused by a focusing optical unit 72 on or in the material 1. The laser beam 60 causes material modifications 3 in the material 1. The beamforming optical unit 9 can be rotated in particular, so that, for example, a preferred direction or an axis of symmetry of the laser beam can be adapted to the feed trajectory.

The feed device 8 can move the material 1 below the laser beam 60 with a feed V in this case, so that the laser beam 60 introduces material modifications 3 along the desired severing line 2. In particular, in the figure shown, the feed device 8 comprises a first part 80 which can move the material 1 along an axis. In particular, the feed device can also have a second part 82, which is configured to rotate the laser beam 60 around the z axis, or around the beam propagation direction, so that the long axis of the beam cross section perpendicular to the beam propagation direction is always tangential to the desired severing line 2, in order to thus cause crack propagation along the severing line 2.

Insofar as the orientation of the long axis of the beam cross section can be determined both by the beamforming optical unit 9 and by the second part 82 of the feed device, it is thus also possible to use either the orientation possibility of the beamforming optical unit 9 or of the second part 82 of the feed device. However, both possibilities can also be used in complement to one another.

For this purpose, the feed device 8 can be connected to a control device 5, wherein the control device 5 converts the user commands of a user of the device into control commands for the feed device 8. In particular, predefined cutting patterns can be stored in a memory of the control device 5 and the processes can be automatically controlled by the control device 5.

The control device 5 can in particular also be connected to the laser 6. The control device 5 can in this case set the laser pulse energy of the laser pulses of the laser 6 or request or trigger the output of a laser pulse or laser pulse train. The control device 5 can also be connected to all mentioned components and thus coordinate the material processing.

In particular, a position-controlled pulse triggering can thus be implemented, wherein an axis encoder of the feed device 8 is read out and the axis encoder signal can be interpreted by the control device as a location specification, for example. It is thus possible that the control device 5 automatically triggers the emission of a laser pulse or laser pulse train when, for example, an internal adding unit, which adds the covered distance, reaches a value and resets to 0 after reaching it. Thus, for example, a laser pulse or laser pulse train can be emitted into the material 1 automatically at regular intervals.

In that the feed speed and the feed direction and thus the severing line 2 are also processed in the control device 5, the laser pulses or laser pulse trains can be emitted automatically.

The control device 5 can also calculate a distance dM or location, at which a laser pulse train or laser pulse is to be emitted, on the basis of the measured speed and the base frequency provided by the laser 6.

In that the laser pulses or pulse trains are emitted in a position-controlled manner, complex programming of the severing process is omitted. Freely selectable process speeds can moreover be implemented easily.

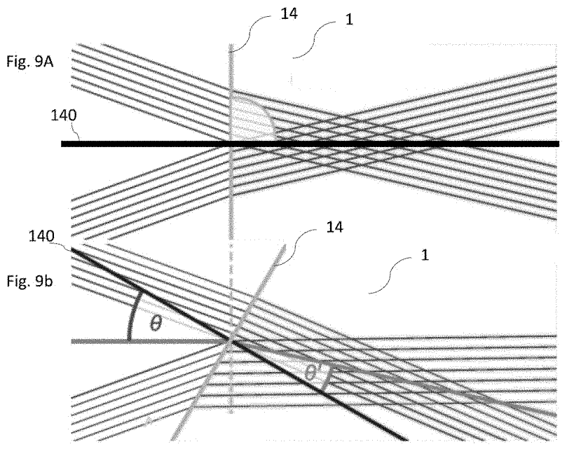

FIG. 9 shows how a quasi-non-diffracting beam is introduced into the material 1 from the partial laser beams after a beamforming optical unit 9. In FIG. 9A, the partial laser beams are incident on the surface 14 of the material symmetrically to the surface normal 140 of the material 1. In particular, the laser beam is thus incident as a whole at a right angle on the surface 14. Correspondingly, the elongated modification zone 602 is aligned in parallel to the surface normal 140, thus in particular does not experience refraction. However, the partial laser beams are very probably incident at an angle on the material surface 14, so that they are refracted according to Snell's law of refraction. The length of the elongated modification zone 602 in the material 1 may be determined by the index of refraction of the material 1 and the angle of incidence of the partial laser beams. Material modifications 3 can be introduced into the material 1 along the elongated modification zone 602.

FIG. 9B shows a situation in which the partial laser beams are not introduced into the material 1 symmetrically to the surface normal 140, but at an angle θ. An elongated modification zone 602 is thus formed in the material, which does not extend in parallel to the surface normal 140, but is refracted at a certain angle θ′. It is thus possible to introduce material modifications 3 into the material 1 which do not extend in parallel to the surface normal 140. A material 1 can thus be severed at an angle θ′, for example.

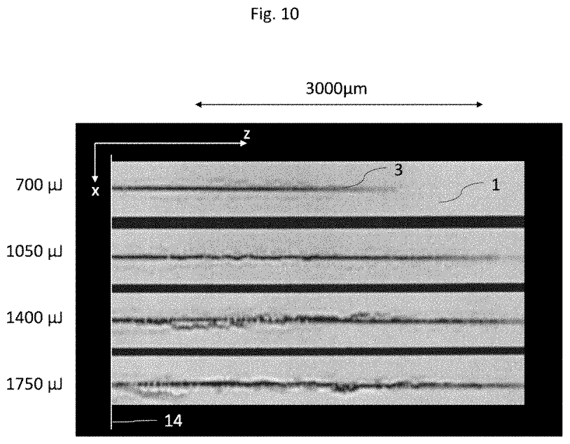

FIG. 10 shows microscope pictures of the material modifications 3 which have been introduced into the material 1 for various pulse energies. For this purpose, the elongated modification zone 602 penetrated the surface 14 of the material 1. Accordingly, the material modifications 3 shown each begin at the surface 14. At a pulse energy of 700 μJ, a first elongated modification zone 602 was generated which was shorter than the material thickness L_{M}. Accordingly, the material modification ends before it reaches the lower surface. To enlarge the elongated modification zones 602, the pulse energy was increased, as shown above in particular in FIG. 3F. For example, at a pulse energy of 1400 μJ, an elongated modification zone 602 was generated which was twice as long as at 700 μJ. In principle, however, a linear relationship does not have to exist between the length of the elongated modification zone and the pulse energy. However, it is possible that the relationship between length of the elongated modification zone and pulse energy can be approximated in sections by a linear relationship. Accordingly, the generated elongated modification zone 602 was greater than 1.5×L_{M}, so that a material modification 3 was generated in the material 1 which extends between the two opposing material surfaces.

If applicable, all individual features which are represented in the exemplary embodiments can be combined and/or exchanged with one another without leaving the area of the invention.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

1 material
10 first material half
12 second material half
14 surface
140 surface normals
2 severing line
20 severing surface
3 material modification
30 material modification area
300 material ejection
32 crack
4 beam cross section
41 main order
43 secondary order
5 control device
6 laser
60 laser beam
600 focus zone
602 modification zone
62 continuous wave CO2 laser
620 temperature gradient
65 hollow core fibre
7 focusing unit
70 mirror
72 focusing optical units
8 feed device
80 first part of the feed device
800 support surface
82 second part of the feed device
9 beamforming optical unit
11 chemical bath
110 reaction bubbles
L_{M} thickness of the material
dA external diameter of the material ejection
dM spacing of the material modifications
FZ tensile force

1. A method for severing an at least partially transparent material, the method comprising:
focusing ultrashort laser pulses, as individual laser pulses and/or as pulse trains, in the material so that a resulting modification zone elongated in a beam propagation direction enters the material and penetrates at least one surface of the material, wherein each pulse train comprises multiple sub-laser pulses,
introducing a plurality of material modifications along a severing line into the material via the laser pulses, and
severing the material along the severing line,
wherein
a pulse energy of the individual laser pulses or a sum of pulse energies of the sub-laser pulses is in a range from 500 μJ to 50 mJ, and a length of the modification zone in the beam propagation direction is greater than a thickness of the material L_{M}.

2. The method according to claim 1, wherein the length of the modification zone is greater than 1.5×L_{M}.

3. The method according to claim 1, wherein the length of the modification zone is greater than 2×(200 μm)+L_{M}.

4. The method according to claim 1, wherein severing the material comprises applying a thermal stress along the severing line and/or applying a mechanical stress, and/or performing etching using at least one wet-chemical solution.

5. The method according to claim 1, wherein the material comprises a glass substrate, and/or a stacked substrate system, and/or a silicon wafer.

6. The method according to claim 5, wherein the thickness of the material L_{M} is greater than 1 mm.

7. The method according to claim 1, wherein
the laser pulses have a wavelength between 0.3 μm and 1.5 μm and/or
a pulse length of the individual laser pulses and/or of the sub-laser pulses is in a range from 0.01 ps to 50 ps, and/or
an average power of a laser output is between 150 W and 15 kW.

8. The method according to claim 1, wherein a laser beam formed by the laser pulses and the material are displaceable relative to one another with a feed in order to introduce the plurality of the material modifications into the material along the severing line, wherein the laser beam and the material are alignable in relation to one another at an angle via tilting and/or rotation.

9. The method according to claim 1, wherein a maximum diameter of a beam cross section perpendicular to the beam propagation direction in the modification zone is between 1 and 50 μm.

10. The method according to claim 1, wherein a laser beam formed by the laser pulses comprises a quasi-non-diffracting beam at least in the elongated modification zone.

11. The method according to claim 10, wherein the laser beam has a non-radially symmetric beam cross section perpendicular to the beam propagation direction, wherein the beam cross section or an envelope of the beam cross section has an elliptical shape.

12. The method according to claim 11, wherein a long axis of the non-radially symmetric beam cross section is oriented perpendicular to the beam propagation direction along the severing line and/or along the feed direction.

13. The method according to claim 12, wherein the elliptical quasi-non-diffracting beam has a non-negligible interference contrast of less than 0.9 along the long axis.

14. The method according to claim 1, wherein a laser beam formed by the laser pulses is incident at a processing angle on the at least one surface of the material, wherein the processing angle is not a right angle.

15. The method according to claim 14, wherein the processing angle is less than 20° for the thickness of the material being less than 2 mm.

16. The method according to claim 14, wherein the processing angle is less than 10° for the thickness of the material being greater than 2 mm.

17. The method according to claim 1, wherein the individual laser pulses and/or the pulse trains are triggered by a position-controlled pulse triggering from a laser system, wherein the position-controlled pulse triggering is based on a position of a laser beam formed by the laser pulses on the material.
